(19) United States
(12) Patent Application Publication
(10) Pub. No.: US 2015/0206519 A1
(43) Pub. Date: Jul. 23, 2015

(54) MUSICAL DRUM

(71) Applicant: K.H.S. MUSICAL INSTRUMENT CO., LTD., New Taipei City (TW)

(72) Inventor: Yi Hsien LIN, Taoyuan County (TW)

(73) Assignee: K.H.S. MUSICAL INSTRUMENT CO., LTD., New Taipei City (TW)

(21) Appl. No.: 14/189,419

(22) Filed: Feb. 25, 2014

(30) Foreign Application Priority Data
Jan. 17, 2014 (TW) 10321008

(51) Int. Cl. G10D 13/02

(52) U.S. Cl. CPC G10D 13/028; G10D 13/027

(57) ABSTRACT

A musical drum includes a hollow cylindrical shell; a drumhead tightly stretched over and sealing each end of the shell, so as to form a resonance chamber between the drumheads and the shell; and two counterhoops fixed around the two drumheads to hold them on the shell. The shell is provided on at least one end with a flat contact surface for horizontally contacting with the drumhead. The flat contact surface has a radially outer edge forming a curved surface downward extended to an outer circumferential surface of the shell, and a radially inner edge forming a bevel downward extended to an inner circumferential surface of the shell. With the flat contact surface and the curved surface, the drumheads can be more tightly attached to the shell, allowing the vibration of the drumheads to be efficiently transmitted to the shell to produce more saturated resonant frequency and good sound sustainability.

### FIELD OF THE INVENTION

The present invention relates to a percussion instrument of drum, and more particularly to a musical drum having a flat contact surface provided on each end of a shell thereof, so that two drumheads of the musical drum can be more tightly stretched over the two ends of the shell to seal them.

### BACKGROUND OF THE INVENTION

Various types of musical drums are different in pitches mainly because the specifications of their shells are different. Either the circumferential length or the vertical height of the shell will have influence on the drum's pitch. Generally speaking, drums having the same diameter may be a high-pitched drum, a middle-pitched drum or a low-pitched drum, depending on their shell height. The high-pitched drum usually has a smaller height, and the low-pitched drum usually has a larger height. Therefore, a drummer would normally have several drums of different specifications for playing in a musical performance to create sound effect of different pitches.

A common percussion drum mainly includes a hollow cylindrical shell having upper and lower open ends, over each of which a drumhead is covered, and two counterhoops are used to frame and tightly fix the drumheads to the two open ends of the shell. The two counterhoops are then locked together to form the fastening structure of the whole percussion drum. As shown in FIG. 1, a conventional drum shell 10 is formed on along each of its two open ends 11 with a chamfer structure 12, which has a somewhat sharp top edge, and a drumhead 13 is stretched over the open end 11 with its outer peripheral portion in line contact with the sharp top edge of the chamfer structure 12.

However, the drum with the drumheads 13 in line contact with the shell 10 along the sharp top edges of the chamfer structures 12 has relative poor sealing effect between the drumheads and the shell to thereby cause the problem of sound leakage. Although some advanced drums have already adopted the 1/9 chamfer to produce better sound, the problem of sound leakage still exists in practical use of these advanced drums.

In view that the conventional percussion instrument of drum has the problem of sound leakage due to insufficient tight contact between the drumheads and the shell, it is desirable to develop an improved musical drum that enhances the tight contact between the drumheads and the shell to overcome the problem in the prior art drums.

### SUMMARY OF THE INVENTION

A primary object of the present invention is to provide a musical drum that is formed on along each end of a shell thereof with a flat contact surface, and the flat contact surface has a radially outer edge forming a curved surface downward extended to an outer circumferential surface of the shell, so that the drumheads can be more tightly attached to the shell, allowing the vibration of the drumheads to be more efficiently transmitted to the shell to produce more saturated resonant frequency and good sound sustainability.

To achieve the above and other objects, the musical drum according to the present invention includes a shell, two drumheads and two counterhoops. The shell is a hollow cylinder having an upper and a lower open end. The drumheads are separately stretched over the two open ends of the shell, so that a resonance chamber is enclosed in the shell and the drumheads. The counterhoops are externally fixed around the two drumheads to hold them immovable on the shell.

The present invention is characterized in that the shell is provided on at least one of its two ends with a flat contact surface for horizontally contacting with the drumhead. The flat contact surface has a radially outer edge forming a curved surface downward extended to an outer circumferential surface of the shell, and a radially inner edge forming a bevel downward extended to an inner circumferential surface of the shell. And, the curved surface includes two parts, which respectively have a first and a second curvature, so that the drumhead can be more tightly and stably attached to the curved surface.

In an operable embodiment, the shell is made of a multilayer sheet material, which includes a first sheet material, a second sheet material and a third sheet material sandwiched between the first and the second sheet material, and the first, second and third sheet materials are pressed together. In an operable embodiment, the first and the second sheet material are made of the same material, and the third sheet material is made of a material different from that of the first and the second sheet material. By changing the material of the shell, the timbre of the musical drum can be changed.

The present invention has the advantage that the drumheads of the musical drum are in close and tight contact with the flat contact surfaces and the curved surfaces at the radially outer edge of the flat contact surfaces to avoid the problem of sound leakage as found in the conventional musical drums. With these arrangements, the vibration of the drumheads can be more efficiently transmitted to the shell to produce more saturated resonant frequency and good sound sustainability.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a fragmentary sectional view of a conventional musical drum;

FIG. 2 is a perspective view of a musical drum according to the present invention;

FIG. 3 is an exploded view of FIG. 2;

FIG. 4 is an enlarged sectional view showing an end of a shell of the musical drum according to a first embodiment of the present invention;

FIG. 5 is an enlarged sectional view showing an end of a shell of the musical drum according to a second embodiment of the present invention;

FIGS. 6A and 6B show that the end of the shell of the musical drum of the present invention includes a bevel that can be designed to have different bevel angles;

FIG. 7 is a fragmentary sectional view of the musical drum according to the present invention;

FIGS. 8A and 8B are two data graphs comparing the musical drum of the present invention and the conventional musical drum in loudness;

FIG. 9 shows two data graphs that compare the musical drum of the present invention and the conventional musical drum in sound sustainability; and

FIG. 10 shows two data graphs that compare the musical drum of the present invention and the conventional musical drum in saturation of sound.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

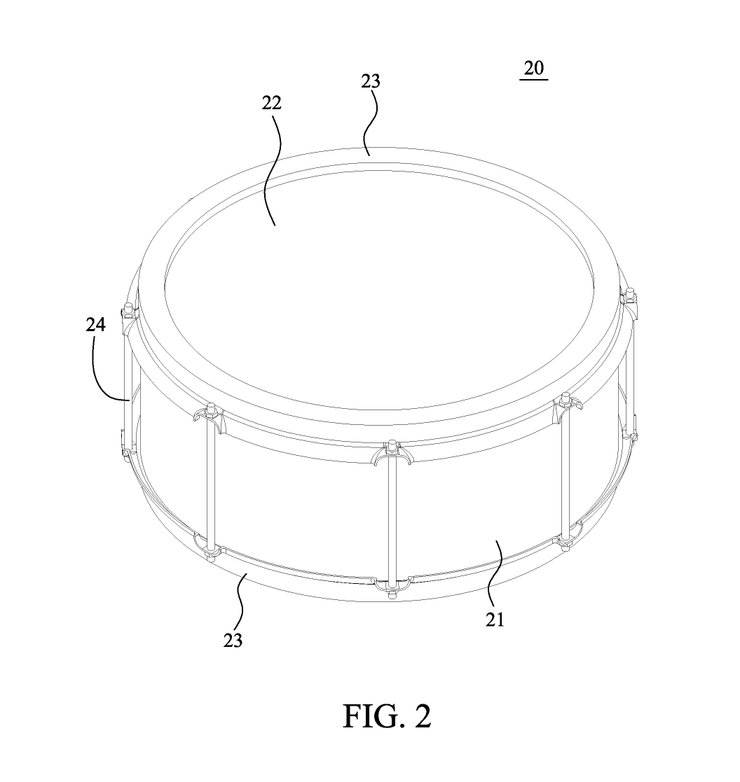

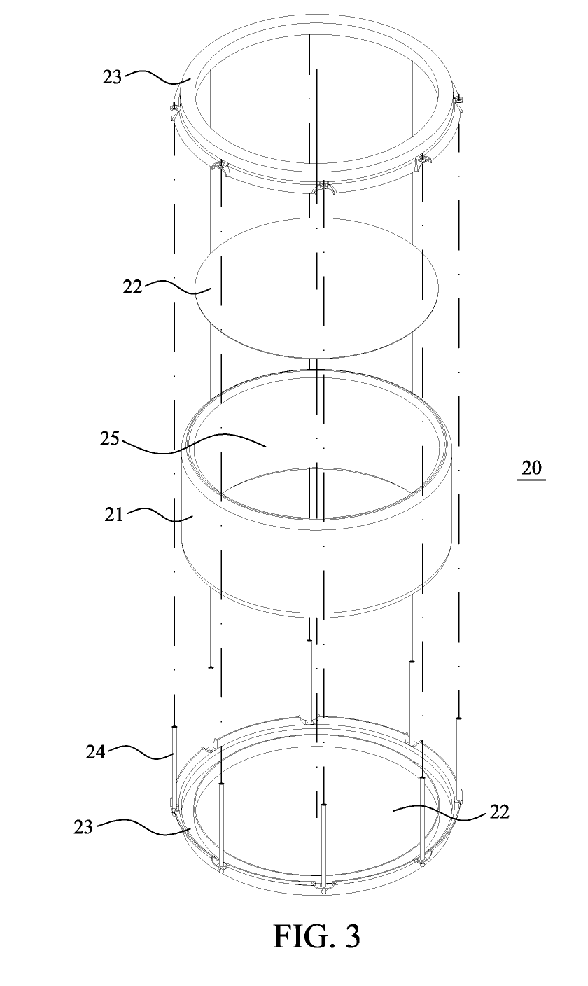

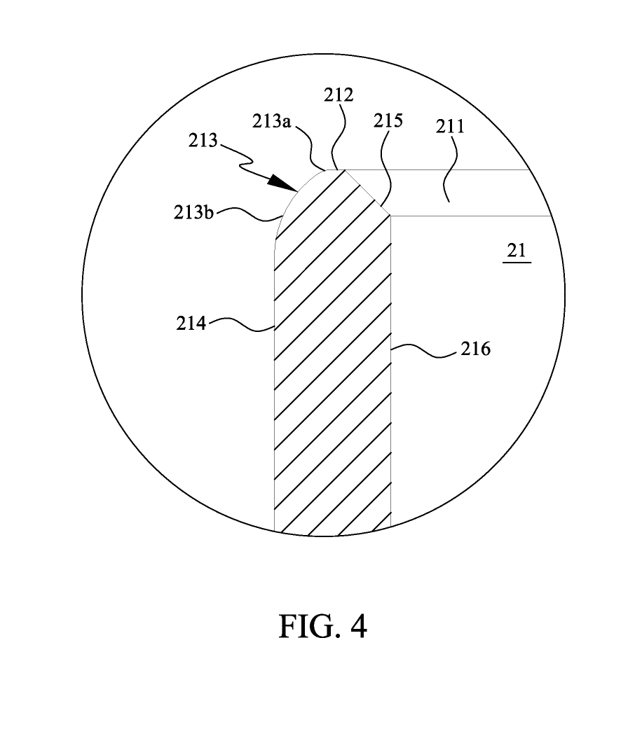

Please refer to FIGS. 2 and 3 that are assembled and exploded perspective views, respectively, of a musical drum 20 according to the present invention. As shown, the musical drum 20 includes a shell 21, two drumheads 22, two counterhoops 23, and a set of tuning members 24. The shell 21 is a hollow cylinder having an upper and a lower end respectively define an opening 211 (see FIG. 4). The two drumheads 22 are separately stretched over the upper and lower ends to tightly seal the openings 211 of the shell 21, so that the drumheads 22 and the shell 21 together enclose a resonance chamber 25 therein. The two counterhoops 23 are separately externally fixed around the two drumheads 22 to hold the drumheads 22 immovable on the shell 21. And, the two counterhoops 23 are locked to each other via the set of tuning members 24.

Please refer to FIG. 4. The upper end of the shell 21 is formed into a flat contact surface 212, with which an upper one of the drumheads 22 horizontally contacts. A radially outer edge of the flat contact surface 212 forms a curved surface 213 downward extended to an outer circumferential surface 214 of the shell 21. The curved surface 213 consists of two parts, which respectively have a first curvature 213a and a second curvature 213b. This design enables the drumhead 22 to be closely, tightly and stably attached to the curved surface 213 without forming any angle and can therefore avoid the occurrence of sound leakage. And, a radially inner edge of the flat contact surface 212 forms a bevel downward extended to an inner circumferential surface 216 of the shell 21.

Since the lower end of the shell 21 has the same structural design as that of the upper end, it is not described in detail herein. In the embodiment as shown in FIG. 4, the shell 21 is made of a single-layer sheet material, which is previously cut to a fixed size according to the circumferential length of the musical drum 20 and is then properly rolled to form the hollow cylinder.

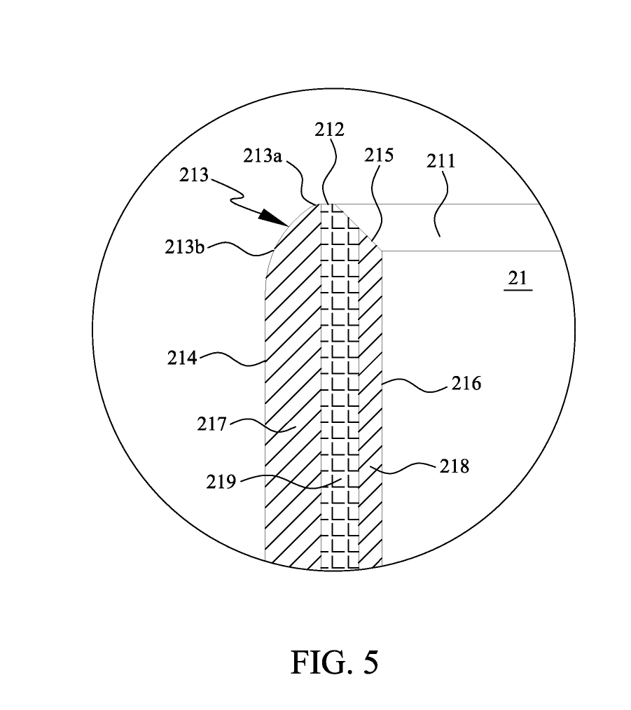

Please refer to FIG. 5. According to another embodiment of the present invention, the shell 21 can be otherwise made of a multilayer sheet material, which is formed by tightly pressing a first sheet material 217, a second sheet material 218, and a third sheet material 219 together, such that the third sheet material 219 is sandwiched between the first and the second sheet material 217, 218. In the illustrated embodiment, the first and the second sheet material 217, 218 are made of the same material while the third sheet material 219 is made of a material different from that of the fist and the second sheet material 217, 218. By changing the types of the sheet materials of the shell 21, it is able to change the timbre of the whole musical drum 20.

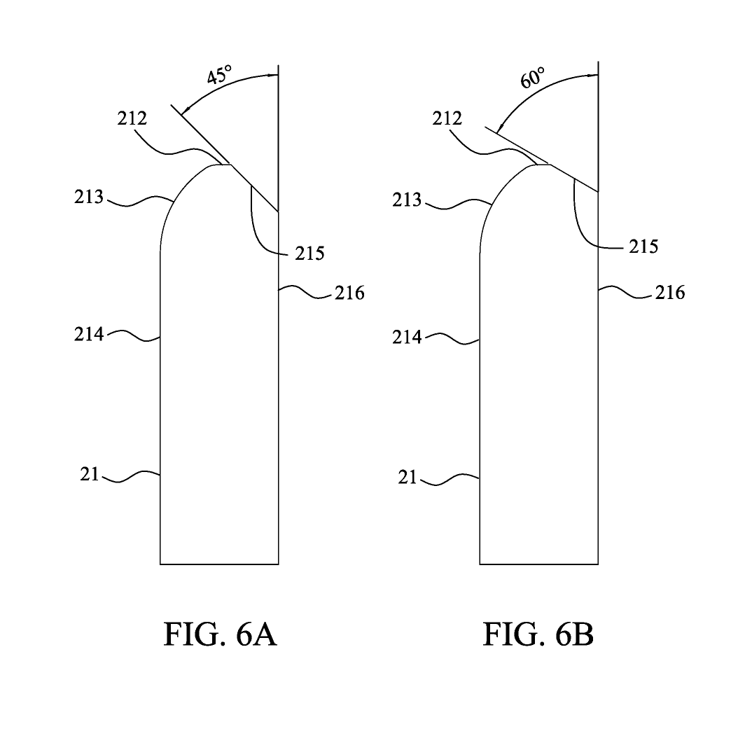

Please refer to FIGS. 6A and 6B. The bevels 215 formed on the shell 21 can have a bevel angle of 45° or 60°, depending on the required specifications. However, it is understood the above-mentioned bevel angles are only illustrative and not intended to limit the actual bevel angle of the bevel 215. One of ordinary skill in the art can also use other bevel angles according to actual need in design.

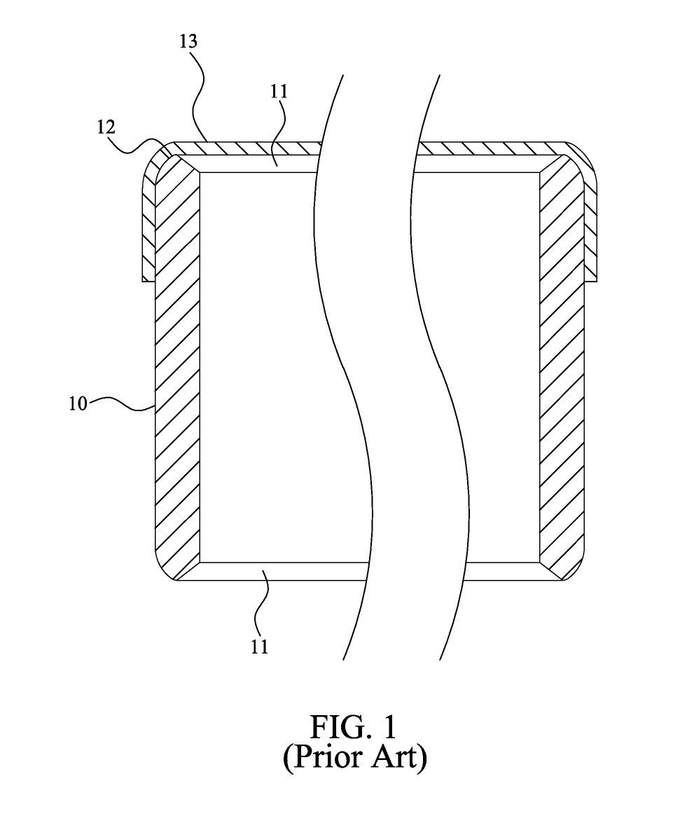

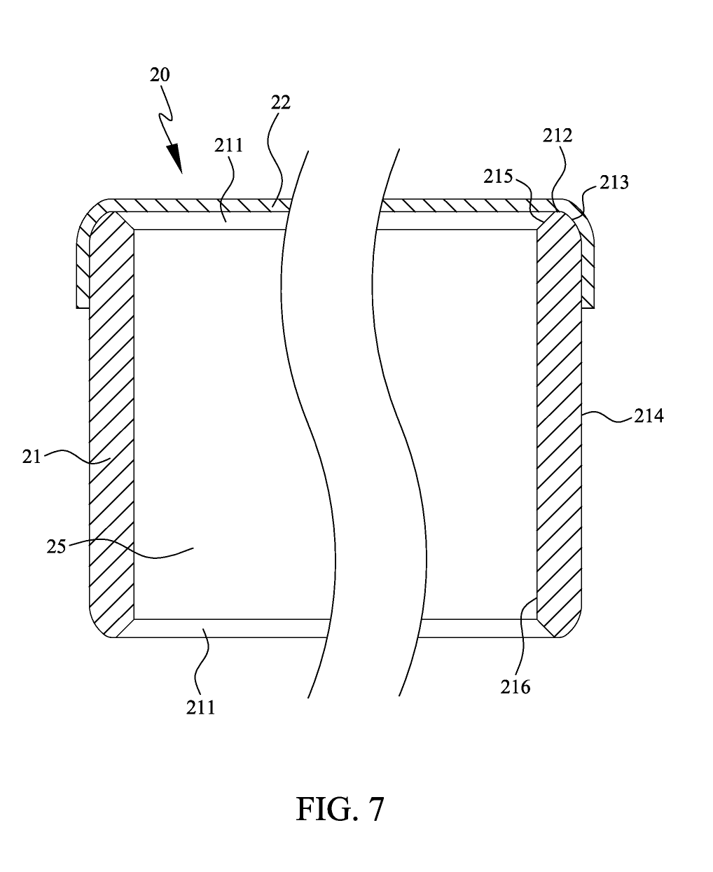

FIG. 7 is a fragmentary sectional view of the musical drum 20 of the present invention. Please refer to FIG. 7 along with the conventional musical drum shown in FIG. 1. As can be clearly seen in FIG. 1, with the conventional musical drum, the drumhead 13 and the shell 10 are in line contact with each other along the sharp top edge of the chamfer structure 12 around the end of the shell 10. However, as can be seen in FIG. 7, with the musical drum 20 of the present invention, the drumhead 22 and the shell 21 are in surface contact with each other along the flat contact surface 212 around the end of the shell 21. Therefore, the contact area between the shell 21 and the drumhead 22 is largely increased compared to the conventional musical drum.

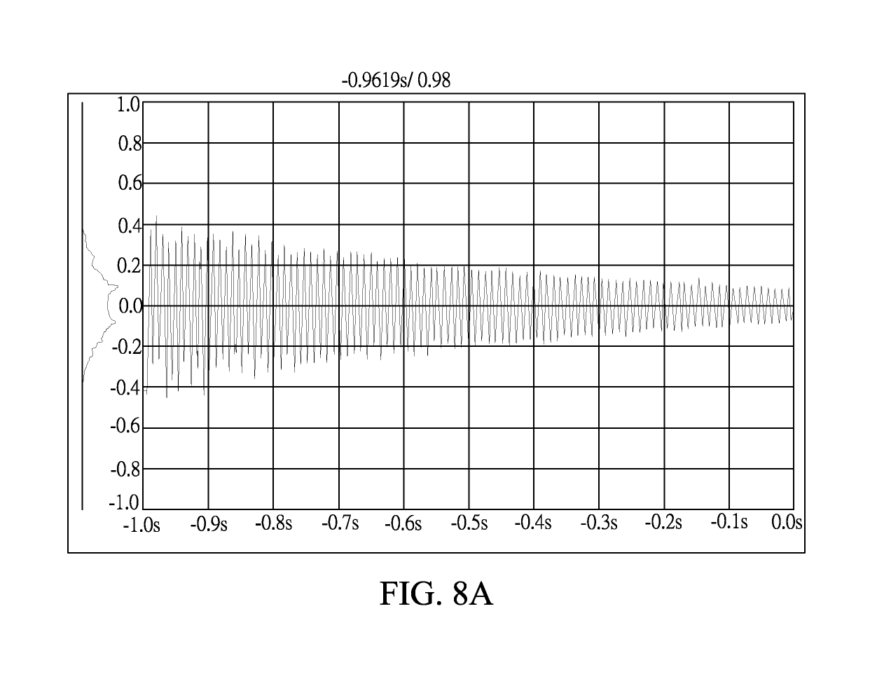

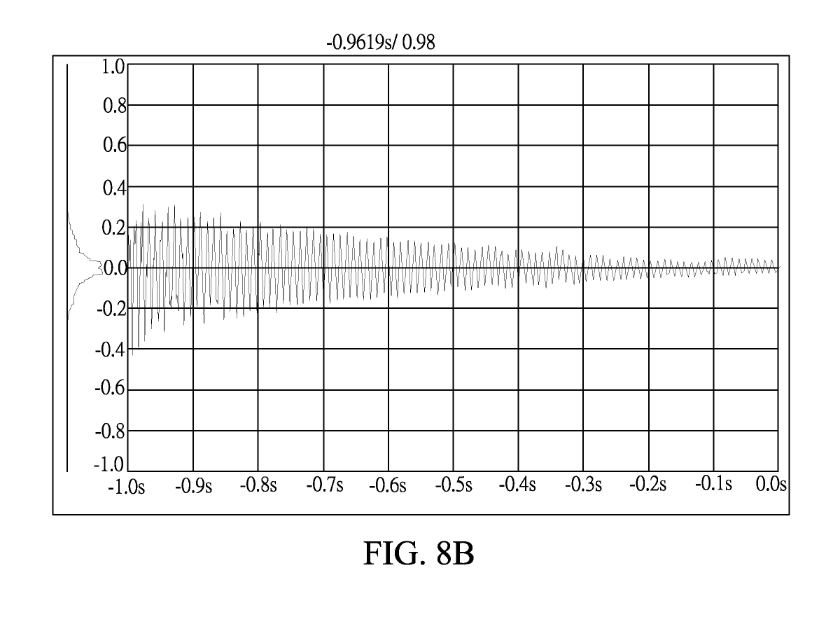

The tone quality of the musical drum 20 of the present invention and of the conventional musical drum are tested in three different methods and the results in each test are compared. Please refer to FIGS. 8A and 8B. FIG. 8A is a sound wave graph for the sound produced by the musical drum 20 that has a shell 21 with a flat contact surface 212 formed on along its end; and FIG. 8B is a sound wave graph for the sound produced by the conventional musical drum that has a chamfer structure 12 formed on along its end. By comparing the two sound wave graphs, it is found the musical drum 20 of the present invention has sound wave amplitude obviously higher than that of the conventional musical drum. This proves that, with the structure of the musical drum 20 of the present invention, the drumhead 22 is better supported on the shell 21 to create a well sealed resonance chamber 25.

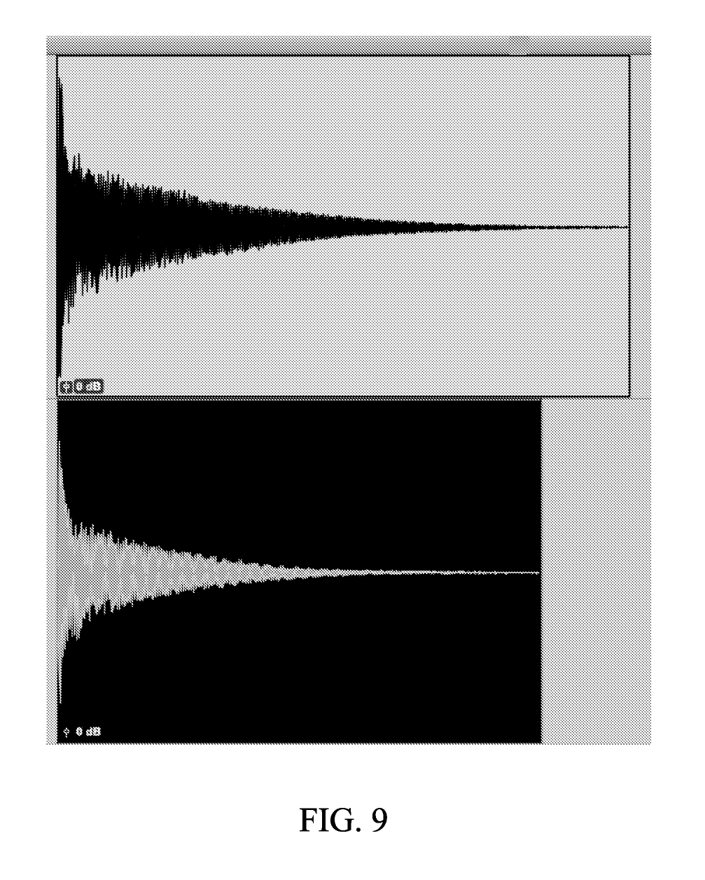

Please refer to FIG. 9, an upper part of which shows the sound wave graph for the sound produced by the musical drum 20 of the present invention, and a lower part of which shows the sound wave graph for the sound produced by the conventional musical drum of FIG. 1. As shown, the musical drum 20 obviously has longer sound wavelength and higher amplitude compared to the conventional musical drum. Therefore, it would not be difficult to find the musical drum 20 has improved sound sustainability.

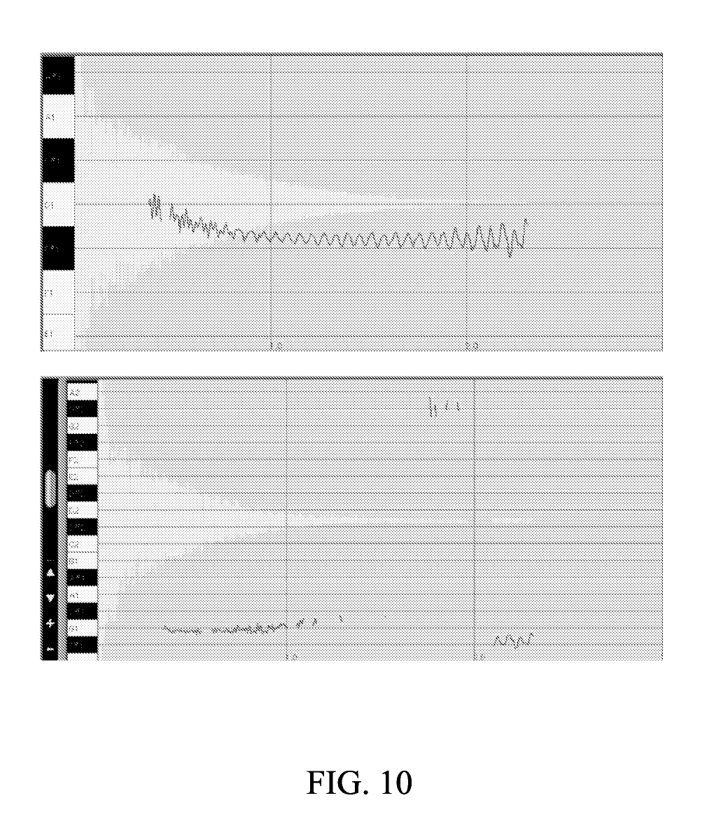

When striking a drum, a relative high tone is produced. This high tone is then gradually lowered with time. Please refer to FIG. 10, an upper part of which is a graph analyzing the tone of the sound produced by striking the musical drum 20, and a lower part of which is a graph analyzing the tone of the sound produced by the conventional musical drum. By comparing the two graphs, it can be found that the amplitude of the musical drum 20 is gradually lowered in a stable curve while the amplitude of the conventional musical drum is lowered in a sawtooth-like curve. Therefore, it can be easily found the musical drum 20 of the present invention has improved saturation of sound.

In summary, in the present invention, by providing the flat contact surface 212 and the two-curvature curved surface 213, the drumhead 22 can have large contact area with the shell 21 and be more tightly attached to the shell 21 to thereby overcome the problem of sound leakage as found in the conventional musical drum that has a chamfer structure presenting a sharp top edge. With the design of the present invention, the vibration of the drumhead 22 of the musical drum 20 can be more efficiently transmitted to the shell 21 to make the resonant frequency have increased saturation and smoothness and to increase the sound sustainability.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A musical drum comprising a hollow cylindrical shell, two drumheads separately stretched over an upper and a lower end of the shell to thereby form a resonance chamber between the drumheads and the shell, and two counterhoops separately externally fixed around the two drumheads to hold the drumheads immovable on the shell; being characterized in that the shell is provided on along at least one of the upper and lower ends with a flat contact surface, with which a corresponding one of the drumheads horizontally contacts.

2. The musical drum as claimed in claim 1, wherein the flat contact surface has a radially outer edge formed into a curved surface to downward extend to an outer circumferential surface of the shell.

3. The musical drum as claimed in claim 2, wherein the curved surface consists of two parts, which respectively have a first curvature and a second curvature.

4. The musical drum as claimed in claim 2, wherein the flat contact surface has a radially inner edge formed into a bevel to downward extend to an inner circumferential surface of the shell.

5. The musical drum as claimed in claim 1, wherein the shell is made of a multilayer sheet material including a first sheet material, a second sheet material and a third sheet material sandwiched between the first and the second sheet material, and the first, second and third sheet materials being pressed together.

6. The musical drum as claimed in claim 5, wherein the first and the second sheet material are made of the same material, and the third sheet material is made of a material different from that of the first and the second sheet material.
